(19) United States
(12) Patent Application Publication
(10) Pub. No.: US 2024/0362848 A1
(43) Pub. Date: Oct. 31, 2024

(54) AI-BASED HIGH-SPEED AND LOW-POWER 3D RENDERING ACCELERATOR AND METHOD THEREOF

(71) Applicant: Korea Advanced Institute of Science and Technology, Daejeon (KR)

(72) Inventors: Hoi Jun YOO, Daejeon (KR); Dong hyeon HAN, Daejeon (KR)

(73) Assignee: Korea Advanced Institute of Science and Technology, Daejeon (KR)

(21) Appl. No.: 18/628,865

(22) Filed: Apr. 8, 2024

(30) Foreign Application Priority Data
Apr. 28, 2023 (KR) 10-2023-0056064

(51) Int. Cl. G06T 15/00; G06F 3/01; G06T 7/11; G06V 10/56; G06V 10/764; G06V 10/82

(52) U.S. Cl. CPC G06T 15/00; G06F 3/013; G06T 7/11; G06V 10/56; G06V 10/764; G06V 10/82

(57) ABSTRACT

Provided is a 3D rendering accelerator based on a DNN trained using a weight of the DNN using a plurality of 2D photos obtained by imaging the same object from several directions and then configured to perform 3D rendering using the same, the 3D rendering accelerator including a VPC configured to create an image plane for a 3D rendering target from a position and a direction of an observer, divide the image plane into a plurality of tile units, and then perform brain imitation visual recognition on the divided tile-unit images to determine to reduce a DNN inference range, an HNE including a plurality of NEs having different operational efficiencies and configured to accelerate DNN inference by dividing and allocating tasks, and a DNNA core configured to generate selection information for allocating each task to one of the plurality of NEs based on a sparsity ratio.

### BACKGROUND OF THE INVENTION

### Field of the Invention

The present invention relates to a three-dimensional (3D) rendering accelerator and a method thereof, and more particularly to an artificial intelligence (AI)-based high-speed and low-power 3D rendering accelerator and a method thereof for realizing the metaverse on mobile devices.

### Description of the Related Art

A deep neural network (DNN), a type of machine learning technology, has been used in various fields such as voice recognition and image analysis, and recently, DNN technology has also been used for high-performance 3D rendering.

A 3D rendering method based on a DNN (for example, NeRF (Neural Radiance Fields)) is a method that enables 3D rendering by assuming RGB values through DNN inference, allowing even general users to easily create and reconstruct 3D content. Therefore, the method has a characteristic in that it is possible to increase a degree of freedom of virtual space and significantly reduce communication bandwidth required for sharing 3D content.

Such DNN-based 3D rendering is an algorithm having high potential for future development due to low memory usage and convenience. However, a significantly low rendering speed has emerged as a problem. For example, even with acceleration from an NVIDIA V100 server, DNN-based 3D rendering is currently not mainstream in 3D rendering due to unrealistic rendering speeds, such as taking 30 seconds to render one image.

In particular, the speed of DNN-based 3D rendering is low since operational requirements of DNN inference are significantly high.

Therefore, to realize the metaverse through DNN-based 3D rendering, rendering acceleration technology available in VR/AR (Virtual Reality/Augmented Reality) headsets needs to be achieved by implementing low power while increasing the rendering speed to high speed (for example, at least 30 FPS (frames-per-second)).

(Non-Patent Literature 1) [1] B. Mildenhall et al., “NeRF: Representing scenes as neural radiance fields for view synthesis,” in 16th European Conference on Computer Vision (ECCV), 2020, pp. 405-421.

(Non-Patent Literature 2) [2] MetaVRain: A 133 mW Real-time Hyper-realistic-3D-NeRF Processor with 1D-2D Hybrid-Neural-Engines for Metaverse on Mobile Devices, ISSCC 2023 published.

### SUMMARY OF THE INVENTION

To solve the above problem, the present invention provides an AI-based high-speed and low-power 3D rendering accelerator and a method thereof capable of minimizing the number of required samples by expressing a 3D space in advance using voxels and taking only samples located inside voxels when performing sampling to significantly reduce the operation quantity while minimizing external memory access, thereby improving rendering speed.

In addition, the present invention provides an AI-based high-speed and low-power 3D rendering accelerator and a method thereof that improves operational efficiency by adopting both a 1D NE (Neural Engine) utilizing data sparsity and a 2D NE maximizing data reusability and dividing and allocating each of tasks having the reduced operation quantity to the 1D NE and the 2D NE according to a sparsity ratio of an operation target image, thereby improving rendering speed.

In addition, the present invention provides an AI-based high-speed and low-power 3D rendering accelerator and a method thereof capable of reusing a pixel value of a previous frame according to a similarity between the previous frame and a current frame when a location of an observer changes to effectively reduce the number of pixels necessary for rendering, thereby reducing the operation quantity of a DNN to improve rendering speed.

In addition, the present invention provides an AI-based high-speed and low-power 3D rendering accelerator and a method thereof capable of minimizing circuit complexity by approximating and replacing a sinusoidal function with a polynomial including a quadratic function and a modulo function during positional encoding, which is essential in DNN-based 3D rendering operation, capable of reducing power and area consumption by generating several positional encoding results within one cycle, and as a result, capable of accelerating DNN-based 3D rendering.

In accordance with an aspect of the present invention, the above and other objects can be accomplished by the provision of a three-dimensional (3D) rendering accelerator based on a deep neural network (DNN) trained using a weight of the DNN using a plurality of two-dimensional (2D) photos obtained by imaging the same object from several directions and then configured to perform 3D rendering using the same, the 3D rendering accelerator including a visual perception core (VPC) configured to create an image plane for an object that is a 3D rendering target from a position and a direction of an observer, divide the image plane into a plurality of tile units, and then perform brain imitation visual recognition on the divided tile-unit images to determine to reduce a DNN inference range required for 3D rendering, a hybrid neural engine (HNE) including a plurality of neural engines (NEs) having different operational efficiencies according to input sparsity and configured to accelerate DNN inference included in the DNN inference range determined to be reduced by dividing and allocating tasks each having reduced operation quantity for the DNN inference to the plurality of NEs, and a dynamic neural network allocation (DNNA) core configured to generate selection information for allocating each of the tasks to one of the plurality of NEs based on a sparsity ratio of each of the tile-unit images.

Preferably, the VPC may include a temporal familiarity unit (TFU) configured to determine a reused pixel value, which is a pixel value of a previous frame allowed to be reused, by evaluating familiarity of the previous frame and a current frame when the position of the observer changes, determine DNN inference target pixels that require DNN inference among pixels of the current frame in consideration of the reused pixel value, and then generate a binary map representing the DNN inference target pixels, and a spatial attention unit (SAU) configured to express the object using low-resolution voxels generated in advance, then exclusively generate coordinates located inside the voxels in a gaze direction of the observer as sample coordinates subjected to DNN inference, and exclusively generate coordinates located inside the voxels corresponding to the DNN inference target pixels as sample coordinates.

Preferably, the HNE may include a 1D NE configured to skip a corresponding operation when there is 0 in input data, a 2D NE configured to reuse data regardless of whether 0 is present in input data, an input/output memory (Input Output MEMory, hereinafter referred to as IOMEM) configured to store input/output values of the 1D NE and the 2D NE, and a modulo-based positional encoding unit (hereinafter referred to as Mod-PEU) configured to generate a sine wave using an approximation formula including a quadratic function and a modulo function and perform positional encoding using the sine wave.

Preferably, the DNNA core may include an output zero pattern extractor configured to determine some of the DNN inference target pixels as sparsity reference pixels for each of the tile-unit images using a centrifugal sampling (CS) method, and extract an output zero pattern of each of the sparsity reference pixels, a bitmask generator configured to collect an output zero pattern for each of the sparsity reference pixels using a bitwise OR operation to generate a bitmask representing the sparsity ratio, and a selection information generator configured to generate selection information for allocating each of the tasks to one of the plurality of NEs according to a number of 0s in the bitmask.

In accordance with another aspect of the present invention, there is provided a 3D rendering method using a 3D rendering accelerator based on a DNN trained using a weight of the DNN using a plurality of 2D photos obtained by imaging the same object from several directions and then configured to perform 3D rendering using the same, the 3D rendering method including creating an image plane for an object that is a 3D rendering target from a position and a direction of an observer, dividing the image plane into a plurality of tile units, and then performing brain imitation visual recognition on the divided tile-unit images to determine to reduce a DNN inference range required for 3D rendering, determining a DNN reference method of each of the tile-unit images based on a sparsity ratio of each of the tile-unit images by dividing and allocating operation tasks of DNN inference included in the DNN inference range to a plurality of NEs having different operational efficiencies according to input sparsity, and accelerating the DNN inference using the DNN reference method determined in the determining a DNN reference method.

Preferably, the creating may include expressing the object using low-resolution voxels generated in advance, and then exclusively generating coordinates located inside the voxels in a gaze direction of the observer as sample coordinates subjected to DNN inference, determining a reused pixel value, which is a pixel value of a previous frame allowed to be reused, by evaluating familiarity of the previous frame and a current frame when the position of the observer changes, and determining DNN inference target pixels that require DNN inference among pixels of the current frame in consideration of the reused pixel value, and determining whether to continue inference and whether additional sampling is necessary based on a result of the DNN inference.

Preferably, the determining a DNN reference method may include determining some of the DNN inference target pixels as sparsity reference pixels for each of the tile-unit images using a CS method, and extracting an output zero pattern of each of the sparsity reference pixels, collecting an output zero pattern for each of the sparsity reference pixels using a bitwise OR operation to generate a bitmask representing the sparsity ratio, and generating selection information for allocating each of tasks for the DNN inference to one of the plurality of NEs according to a number of 0s in the bitmask.

Preferably, the accelerating the DNN inference may include inferring each of the tasks based on the selection information, and DNN-inferring corresponding tasks using any one of NEs allocated to each of the tasks among a 1D NE that skips a corresponding operation when there is 0 in input data and a 2D NE that reuses data regardless of whether there is 0 in input data, and generating a sine wave using an approximation formula including a quadratic function and a modulo function and performing positional encoding using the sine wave.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic block diagram of an AI-based high-speed and low-power 3D rendering accelerator according to an embodiment of the present invention;

FIG. 2 is a schematic block diagram of a TFU according to an embodiment of the present invention;

FIG. 3 is a schematic block diagram of an SAU according to an embodiment of the present invention;

FIGS. 4 to 9 are diagrams for describing an operation of a VPC according to an embodiment of the present invention;

FIG. 10 is a schematic block diagram of an HNE according to an embodiment of the present invention;

FIG. 11 is a diagram for describing an operation of the HNE according to an embodiment of the present invention;

FIGS. 12 to 16 are diagrams for describing a configuration and operation of a modulo-based positional encoding unit (Mod PEU) according to an embodiment of the present invention;

FIG. 17 is a diagram for describing a concept of a DNNA process according to an embodiment of the present invention;

FIG. 18 is a schematic block diagram of a DNNA core according to an embodiment of the present invention;

FIGS. 19 to 22 are diagrams for describing an operation of the DNNA core according to an embodiment of the present invention;

FIGS. 23 to 29 are diagrams for describing a method of accelerating AI-based high-speed and low-power 3D rendering; and

FIGS. 30 to 32 are diagrams for describing the method of accelerating AI-based high-speed and low-power 3D rendering.

### DETAILED DESCRIPTION OF THE INVENTION

Hereinafter, embodiments of the present invention will be described with reference to the attached drawings, and will be described in detail so that those skilled in the art may easily practice the present invention. However, the present invention may be implemented in many different forms and is not limited to the embodiments described herein. Meanwhile, to clearly describe the present invention in the drawings, parts unrelated to the description are omitted, and similar parts are given similar reference numerals throughout the specification. In addition, descriptions of parts, which may be easily understood by those skilled in the art even when detailed descriptions are omitted, are omitted.

Throughout the specification and claims, when a part is described as including a certain component, this means that other components may be further included rather than excluding other components, unless specifically stated to the contrary.

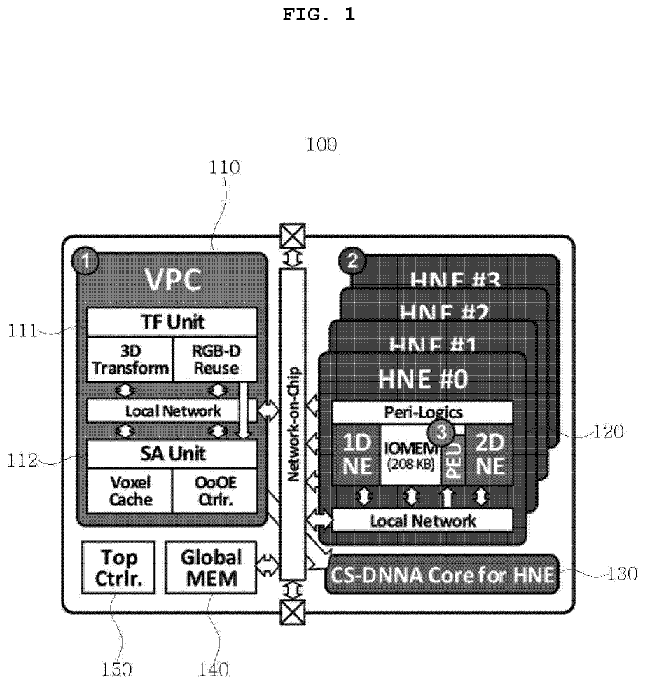

FIG. 1 is a schematic block diagram of an AI-based high-speed and low-power 3D rendering accelerator according to an embodiment of the present invention. Referring to FIG. 1, a 3D rendering accelerator 100 according to an embodiment of the present invention is a DNN-based 3D rendering apparatus trained using a weight of a DNN using a plurality of 2D photos obtained by imaging the same object from various directions and then configured to perform 3D rendering using the same, and includes a visual perception core (hereinafter referred to as “VPC”) 110, a hybrid neural engine (hereinafter referred to as “HNE”) 120, a dynamic neural network allocation core (hereinafter referred to as “DNNA-C”) 130, an external memory Global MEM 140, and a top controller Top Ctrlr. 150.

In addition, each of the above devices (that is, the VPC 110, the HNE 120, the DNNA-C 130, the external memory Global MEM 140, and the top controller Top Ctrlr. 150) performs communication via network-on-chip.

The VPC 110 is a device that reduces the amount of required operation through brain imitation, which generates an image plane for an object subjected to 3D rendering from a position and a direction of an observer, segments the image plane into a plurality of tile units, and then determines to reduce a DNN inference range required for 3D rendering through brain imitation visual recognition of the segmented tile-unit images. In other words, the VPC 110 minimizes the frequency of accessing the external memory required when implementing a BuFF (Bundle-Frame-Familiarity) architecture and significantly reduces the number of tasks to be performed by the HNE 120, thereby contributing to improvement in overall rendering speed.

To this end, the VPC 110 includes a temporal familiarity unit (hereinafter referred to as “TFU”) 111 and a spatial attention unit (hereinafter referred to as “SAU”) 112.

The TFU 111 is a device that performs a temporal familiarity (TF) process, and performs a process of excluding similar operations in a current frame from previous operation results. For example, the TFU 111 reuses rendering results (RGB-D, red, green, blue, and depth) of a previous frame for rendering a current frame to reduce the number of pixels that require rendering, thereby performing a process for speeding up rendering. That is, when the position of the observer changes, the TFU 111 determines a reused pixel value, which is a pixel value of the previous frame that may be reused, by evaluating familiarity of the previous frame and the current frame, reflects the reused pixel value to determine DNN inference target pixels that require DNN inference among pixels of the current frame, and then generates a binary map representing the DNN inference target pixels. A more detailed configuration and operation of the TFU 111 for this purpose will be described later with reference to FIG. 2 and FIGS. 4 to 7.

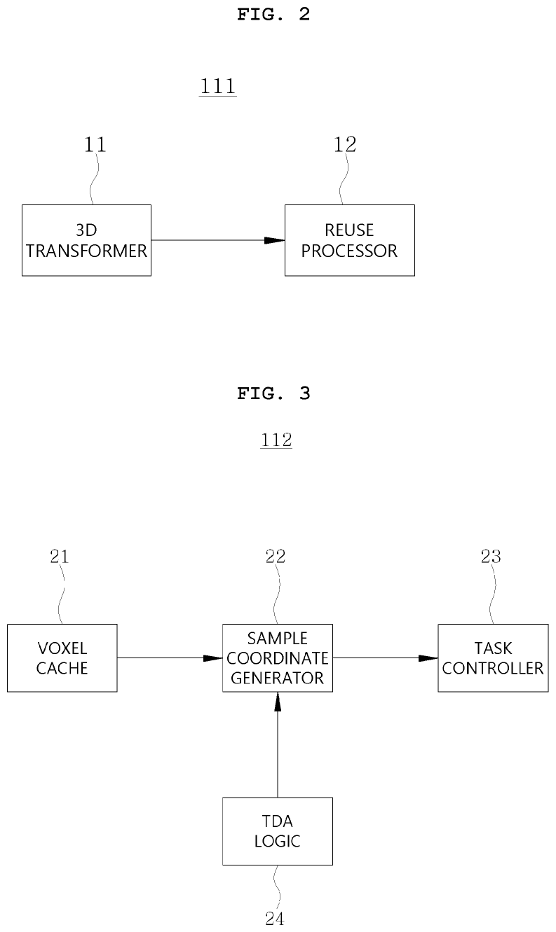

The SAU 112 is a device that performs a spatial attention (SA) process, and performs a process of reducing the operation quantity by remembering an approximate position of an object in a 3D space based on the memory when the DNN is trained. For example, the SAU 112 expresses the 3D space using low-resolution voxels in advance through a DNN trained without voxels, and performs a process for minimizing the number of samples required by sampling only points inside the voxels in a sampling process during a DNN-based 3D rendering operation. In other words, the SAU 112 expresses the object using low-resolution voxels generated in advance, then generates only coordinates located inside the voxels in a gaze direction of the observer as sample coordinates subjected to DNN inference, and generates only coordinates located inside the voxels corresponding to the DNN inference target pixels as sample coordinates. A more detailed configuration and operation of the SAU 112 for this purpose will be described later with reference to FIGS. 3, 8, and 9.

The HNE 120 is a device for rapidly and efficiently accelerating a remaining operation after minimizing the operation quantity required in the VPC 110, includes plurality of neural engines (hereinafter referred to as “NEs”) having different operational efficiencies according to input sparsity by borrowing different architectures, accelerates the remaining DNN inference using the NEs, and divides and allocates tasks for the DNN inference to the plurality of NEs to accelerate DNN inference. In particular, the HNE 120 accelerates DNN inference included in a DNN inference range determined to be reduced in the VPC 110. In other words, the HNE 120 performs DNN inference on tasks in which operation is determined to be performed in the VPC 110, and efficiently accelerates inference using both a 1D NE that utilizes data sparsity and a 2D NE that maximizes data reusability.

In this way, by simultaneously utilizing the 1D NE and the 2D NE, the HNE 120 of the present invention may achieve a rendering speed 3.7 times higher than when sparsity is not utilized. In addition, the HNE 120 of the present invention exhibited energy efficiency at least 2.4 times higher than when accelerated with only either the 1D NE or the 2D NE.

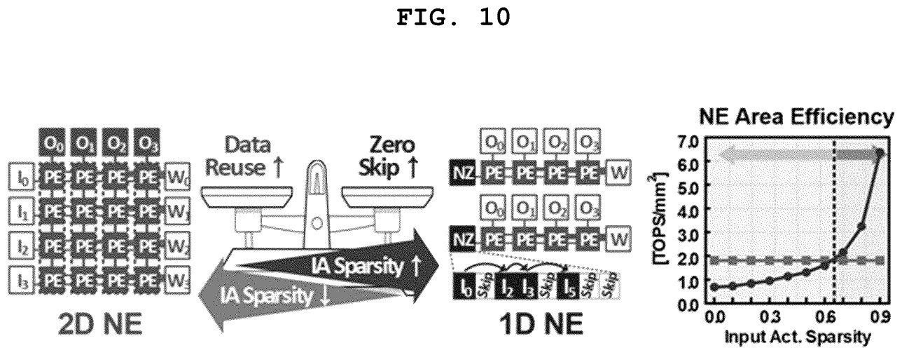

A more detailed configuration and operation of the HNE 120 will be described later with reference to FIGS. 10 to 16.

The DNNA-C 130 is a device for allocating each of the tasks to one of the plurality of NEs included in the HNE 120, and generates selection information for allocating a task to one of the plurality of NEs based on a sparsity ratio of each of the tile-unit images. That is, the DNNA-C 130 separates DNN channels into two groups according to the sparsity ratio of each of the tile-unit images.

To this end, the DNNA-C 130 stores a reference value for determining magnitude of the sparsity ratio. When sparsity of any first tile-unit image output from the VPC 110 is greater than or equal to the reference value, it is determined that sparsity is high, and thus a channel may be allocated to the 1D NE so that the first tile-unit image is processed in the 1D NE. When sparsity of the first tile-unit image is less than the reference value, it is determined that sparsity is low, and thus a channel may be allocated to the 2D NE so that the first tile-unit image is processed in the 2D NE.

A more detailed configuration and operation of the DNNA-C 130 will be described later with reference to FIGS. 17 to 22.

The external memory Global MEM 140 stores predetermined information to operate the 3D rendering accelerator 100. In particular, the external memory Global MEM 140 stores weight values of the DNN.

The top controller Top Ctrlr. 150 controls the operation of the 3D rendering accelerator 100 based on preset control commands or control commands transmitted from the outside.

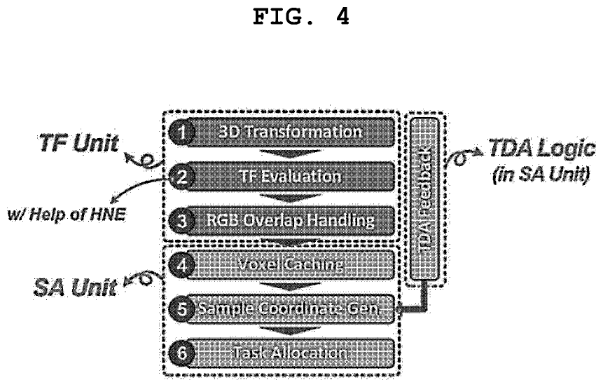

FIG. 2 is a schematic block diagram of the TFU 111 according to an embodiment of the present invention, FIG. 3 is a schematic block diagram of the SAU 112 according to an embodiment of the present invention, and FIGS. 4 to 9 are diagrams illustrating a processing process of six pipeline steps of macro block levels included in the VPC 110.

The configuration and operation of the TFU 111 according to an embodiment of the present invention will be described as follows with reference to FIGS. 1, 2, and 4 to 7.

As illustrated in FIG. 2, the TFU 111 includes a 3D transformer 11 and a reuse processor 12, and performs a 3D transformation step, a TF evaluation step, and an RGB overlap handling step among the six pipeline steps of the macro block levels illustrated in FIG. 4. In particular, the 3D transformer 11 performs the 3D transformation step, and the reuse processor 12 performs the TF evaluation step and the RGB overlap handling step. Meanwhile, the TFU 111 may further include an I/O buffer and a Tile-wise TF Handler (TTH).

First, the TFU 111 reuses RGB-D pixels of the previous frame to fill current frame pixels. To this end, after performing 3D transformation on the tile-unit images, the 3D transformer 11 rotates and parallel-transfers RGB values for each pixel of the previous frame based on change values of a position and a direction of the observer, and projects the RGB values onto corresponding pixels of the current frame.

Meanwhile, since a pixel in a tile have the characteristic of moving to a similar place even after 3D transformation (that is, data locality), the 3D transformer 11 may utilize a relative address-based buffering technique. In this case, when compared to the case where the relative addressing-based buffering technique is not used, the size of the required output buffer may be minimized and external memory access (EMA) may be reduced by 97.9%. In this instance, a known technique may be used as the relative addressing-based buffering technique.

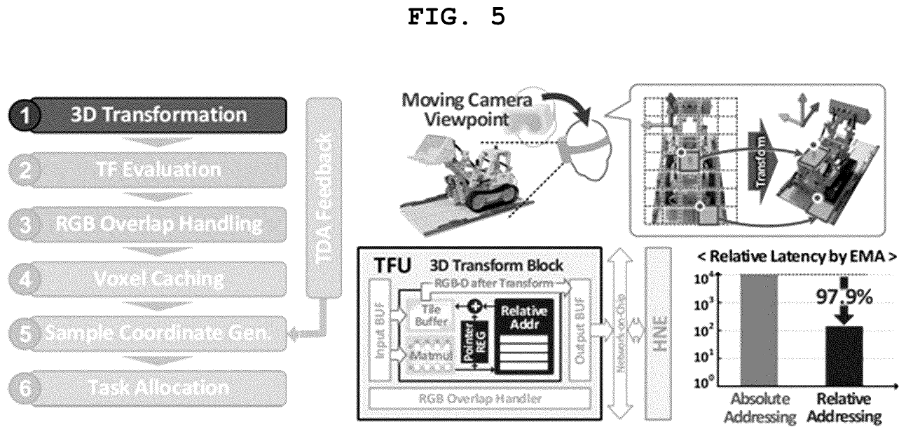

A processing process of the 3D transformer 11 is illustrated in FIG. 5.

FIG. 5 is a diagram for describing a processing process for the 3D transformation step among the six pipeline steps, and illustrates a process of filling pixels of the current frame by rotating and parallel-transferring RGB-D results of the previous frame based on changed positions when the position of the observer changes (moving camera viewpoint).

As such, even though the number of pixels that may be reused through 3D transformation is significantly large, when used for 3D rendering without change, peak signal-to-noise ratio (PSNR) loss of 9.7 dB occurs, causing a problem in that rendering quality is significantly damaged.

Therefore, in the present invention, to prevent this phenomenon, the reuse processor 12 performs the TF evaluation step. That is, the reuse processor 12 predicts color change values in units of pixels of the previous frame and the corresponding current frame, and reuses only RGB values of pixels whose predicted color change values are less than a preset allowable change value.

In this instance, in the TF evaluation step, only a partial operation of the NDD is performed to predict whether an RGB change of a pixel to be reused is large or small, and when the RGB change is predicted to be large, finding a new RGB value is induced without reuse. That is, the TF evaluation step utilizes technology for estimating a change in a DNN inference result to predict a color difference between before and after 3D transformation, and estimates a color change by analyzing only the last few layers affected by camera coordinates using a characteristic in that a color of a sample changes depending on the camera coordinates even though density, which is a result of DNN inference, appears constant regardless of a position of the observer and a viewing direction in DNN-based 3D rendering.

To this end, the reuse processor 12 remembers an input feature map of a camera pose-dependent layer in a previous frame calculation step, and performs partial inference only for the remaining layers when calculating the current frame.

Therefore, the present invention has an advantage of being able to exclude more than 95% of DNN inference while causing only PSNR loss of less than 1 dB.

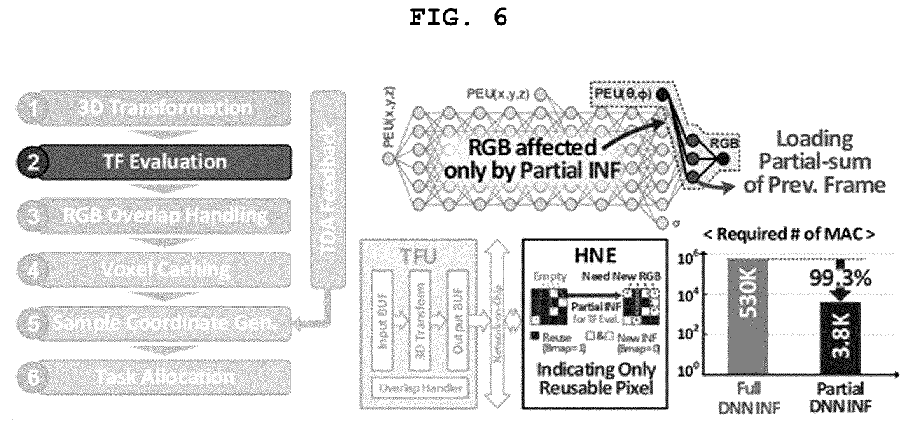

A processing process for this TF evaluation step is illustrated in FIG. 6.

FIG. 6 is a diagram for describing a processing process for the TF evaluation step among the six pipeline steps, and illustrates a process of inferring only a part of the DNN used in DNN-based 3D rendering and determining whether or not the RGB-D values of the previous frame can be reused. Referring to FIGS. 1, 2, and 6, the TFU 111 transmits a transformation result to the HNE 120 and calculates familiarity using the partial INF. Meanwhile, to minimize the overhead of the partial INF, an intermediate feature map of a previous pixel is loaded and color values are updated using an updated viewing direction of the current frame. Since an activation value, which is a result of the previous INF, is loaded and reused, the partial INF exhibits only 0.72% of the operation quantity when compared to the full INF. That is, in the TF evaluation step, an intermediate sum result of the previous frame is remembered and used during partial DNN inference, thereby reducing the required MAC operation by 99.3%. In addition, the TFU 111 performs the TF evaluation step with the help of the HNE 120, and when the HNE 120 completes the partial INF, a binary map Bmap representing reusable pixels is generated.

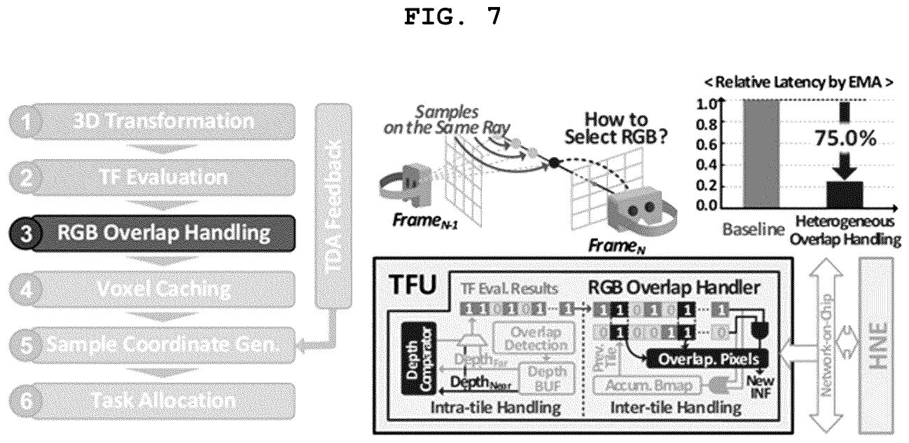

Meanwhile, when an overlap phenomenon occurs in which a plurality of previous frame pixels matches one current frame pixel, the reuse processor 12 performs the RGB overlap handling step to solve intra-tile overlap by selecting an RGB value of a pixel located at a frontmost side among the previous frame pixels where overlap occurs and to solve inter-tile overlap by DNN inference. A processing process for solving the RGB overlap handling step is illustrated in FIG. 7.

FIG. 7 is a diagram illustrating for describing a processing process for the RGB overlap handling step among the six pipeline steps. Referring to FIGS. 1, 2, and 7, the TFU 111 solves problems using different principles when overlap occurs inside a tile and when overlap occurs outside a tile. First, when overlap occurs while moving inside a tile, the TFU 111 selects the closer RGB-D based on the current observer. To this end, the TFU 111 uses a depth comparator during intra-tile processing to select only the one RGB-D pixel closest to the camera origin. Meanwhile, when overlap occurs due to movement between tiles, the TFU 111 performs a new RGB-D operation without depth comparison. To this end, the TTH in the TFU 111 skips depth comparison in inter-tile processing. Instead, an “AND” operation in units of bits is used to find overlapping pixels. All of these different overlap solution methods may reduce external memory access by 75% when compared to selecting RGB-D through depth comparison. In addition, Bmap generated by the AND operation responds to the transformation results of adjacent tiles, and the finally accumulated Bmap indicates whether inference is needed to obtain a new RGB-D value.

As described above, the present invention may reduce the EMA by a total of 99.5% due to heterogeneous overlapping processing, and ultimately the TFU may reuse the RGB-D pixels of the previous frame, which exhibits an effect of an average speed improvement of 48.6 times.

With reference to FIGS. 1, 3, 8, and 9, a configuration and operation of the SAU 112 according to an embodiment of the present invention will be described as follows.

As illustrated in FIG. 3, the SAU 112 includes a voxel cache 21, a sample coordinate generator 22, a task controller 23, and TDA logic 24, and performs a voxel caching step, a sampling coordinate generation step, a task allocation step, and a top-down attention (TDA) step among the six pipeline steps of the macro block levels illustrated in FIG. 4.

The voxel cache 21 stores information about the voxels collected from an external memory.

The sample coordinate generator 22 generates sample coordinates and generates only coordinates inside the voxels corresponding to the DNN inference target pixels among the coordinates on the ray as sample coordinates by emitting a ray based on the binary map.

The task controller 23 determines the number of effective samples for each DNN inference target pixel based on a result of sample coordinate generation, uses a result thereof to classify the tile-unit images into a dense tile or a sparse tile, and then controls input/output to/from the HNE according to the type.

The TDA logic 24 determines whether to continue inference based on a DNN inference result of the HNE 120 and controls a sample coordinate generation operation of the sample coordinate generator. That is, the TDA logic 24 receives an intermediate operation result for any first layer from the HNE 120, and may determine to skip remaining DNN inference steps of the first layer when an intermediate density value included in the intermediate operation result is less than a preset downward threshold. In addition, the TDA logic 24 receives a cumulative density value generated throughout the 3D rendering process from the HNE 120, and may determine to suspend the sample coordinate generation operation oft the sample coordinate generator when the cumulative density value exceeds a preset upward threshold.

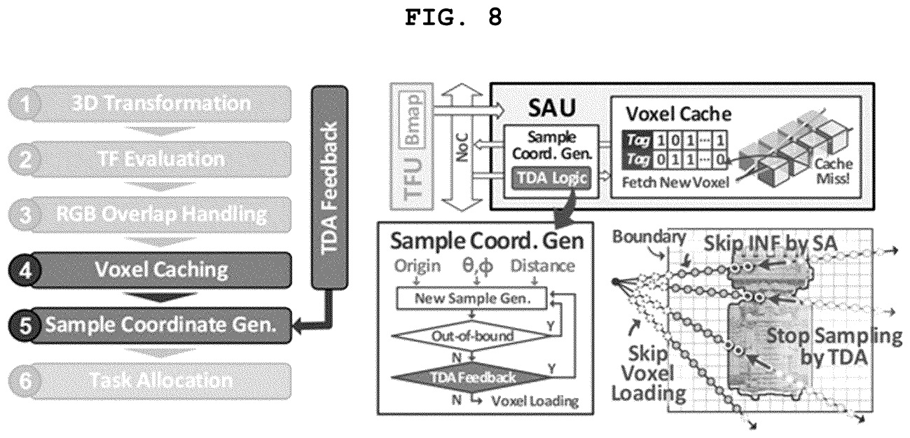

FIG. 8 is a diagram for describing a processing process for the voxel caching step, the sampling coordinate generation step, and the TDA step among the six pipeline steps. Referring to FIGS. 1, 3, and 8, the SAU 112 imports voxel information from an external memory to form coordinates of only samples present in the voxels. In this instance, to minimize duplicate importing of voxels from the external memory, in the voxel caching step, the voxel information is stored in the voxel cache 21, and only voxel information not stored in the voxel cache 21 may be selectively imported later.

Meanwhile, the sample coordinate generator 22 evaluates whether a sample is present inside an attention map and generates coordinates of 8 samples per pixel. In this instance, the sample coordinate generator 22 initially generates 8 sample coordinates, and when the density accumulated through TDA is low, the sample coordinate generator 22 may further sample 8 samples for each corresponding pixel. As a result, the number of coordinates sampled per pixel is a multiple of 8.

In addition, the figure illustrates a process of receiving the accumulated density from the TDA logic 24 and determining whether to continue sample coordinate calculation. In this way, by utilizing the TDA logic 24, the SAU 112 may avoid generation of useless samples.

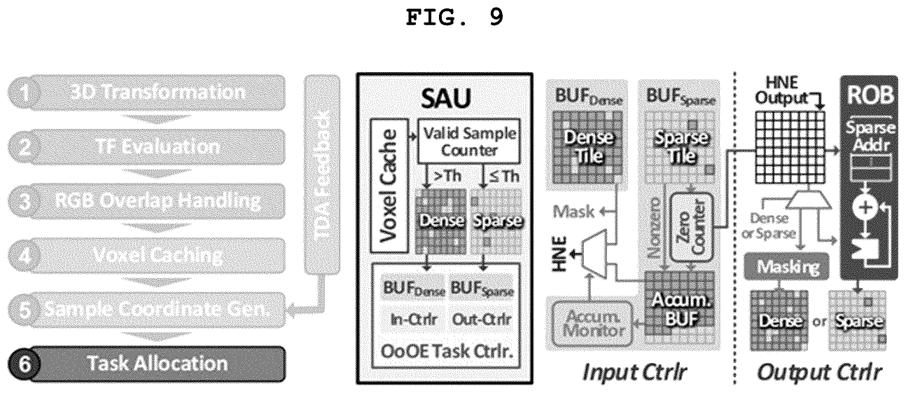

FIG. 9 is a diagram for describing a processing process for the task allocation step among the six pipeline steps. Referring to FIGS. 1, 3, and 9, the task controller 23 collects sample coordinates generated t through the voxel caching step and the sample coordinate generation step, and performs the task allocation step to prepare for input to the HNE 120.

To this end, the task controller 23 first classifies the unit tile images according to the number of pixels to be calculated per unit tile image (that is, the number of effective samples). The task controller 23 classifies the unit tile images as dense tiles when the number of pixels to be calculated is large and classifies the unit tile images as sparse tiles when the number is small. Further, according to the classification result, the dense tiles are masked and input to the HNE 120, and for the sparse tiles, only pixels that need to be operated are accumulated in an accumulation buffer and passed to the HNE 120 to perform an out-of-order operation only when tasks are sufficiently accumulated. That is, the input controller directly passes dense tiles to the HNE. However, for sparse tiles, the input controller waits until input coordinates are sufficiently accumulated in the buffer. A reason therefor is that efficiency of the HNE 120 may be further improved when there are sufficient samples in one tile.

Meanwhile, the output controller decodes an HNE output using a masking unit or a reorder buffer (ROB) to produce a final RGB-D result. In other words, the output controller passes operation results for dense tiles from the HNE 120 through only the masking unit, and in the case of operation results for sparse tiles, the output controller utilizes the ROB to restore the output to the original size and then produces final output therefrom.

As a result, the SAU 112 exhibited an additional average of 23.1 times higher throughput than the TFU 111. In this way, the VPC 110, which combines the TFU 111 and the SAU 112, successfully realized BuFF, which ultimately achieves rendering 1120 times faster than vanilla DNN-based 3D rendering acceleration.

FIG. 10 is a schematic block diagram of an HNE according to an embodiment of the present invention. Referring to FIGS. 1 and 10, the HNE 120 according to an embodiment of the present invention includes a 1D NE 121, a 2D NE 122, and a PEU 123. In addition, the HNE 120 assists in DNN acceleration operation since an IOMEM (In Out MEMory), a WMEM (Weight Memory), a CSMEM (Centrifugal Sampling Memory), a PSMEM (Partial-sum Memory), etc. in which input/output values of the 1D NE 121 and the 2D NE 122 are stored are located on the periphery.

The 1D NE 121 is a NE optimized for data with high data sparsity (that is, sparse input data) by skipping the operation when there is a 0 in the input data. To this end, the 1D NE 121 includes 8 PE units, and each PE unit may simultaneously calculate 32 outputs by receiving a single NZ (nonzero) input activation (IA) value.

The 2D NE 122 is a NE optimized for data with low data sparsity (that is, dense input data) by having a characteristic of reusing data regardless of whether 0 is present in the input data. Accordingly, the 2D NE 122 receives dense IA values without encoding. That is, the 2D NE 122 may receive 32 IA values from the input/output memory (In-out Memory, IOMEM) regardless of sparsity and generate 32 outputs using an adder tree.

Meanwhile, all intermediate partial sums are stored in the PSMEM and sent to the IOMEM after post-processing such as ReLU. In a partial sum aggregation step, output activation values are reordered and assigned independently to the 1D NE 121 and the 2D NE 122. Therefore, each NE (121 or 122) receives only a part of a channel, which leads to the illusion that each NE (121 or 122) is accelerating only a small portion of the DNN. Both the 1D NE 121 and the 2D NE 122 may receive IA values from the IOMEM as well as the PEU 123 to calculate a layer requiring a positional encoding result.

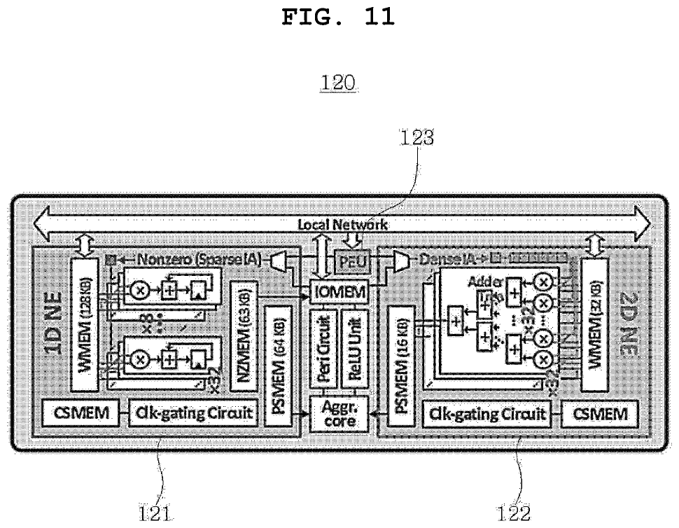

FIG. 11 is a diagram illustrating the 1D NE 121 and the 2D NE 122 having different design philosophies, and is a diagram for describing pros and cons of each of the NEs. Referring to FIGS. 10 and 11, it can be seen that when input sparsity is high, efficiency of the 1D NE 121 increases, and when input sparsity is low, efficiency of the 2D NE 122 increases. For example, the 1D NE 121 exhibits significant performance degradation when the sparsity ratio is less than 60%, while the 2D NE 122 is more advantageous for dense inputs. Therefore, DNN operations remaining after the operation quantity is removed through the VPC are dynamically allocated to the 1D NE 121 and the 2D NE 122 according to the sparsity ratio of the data.

The PEU 123 performs positional encoding using a sine wave. To rapidly and efficiently generate the sine wave that is essential for 3D rendering, the PEU 123 generates the sine wave using an approximation formula including a quadratic function and a modulo function and performs positional encoding using the sine wave. Meanwhile, by applying the modulo function in this way, the PEU 123 is referred to as a modulo-based positional encoding unit (Mod-PEU, Modulo-based PEU).

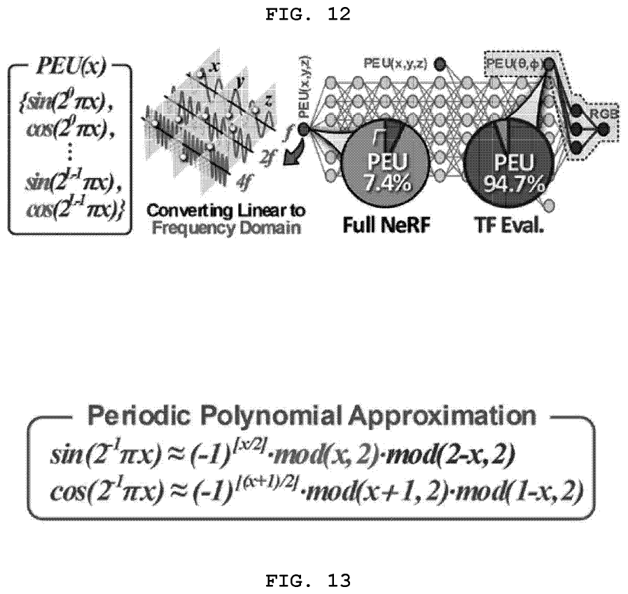

FIGS. 12 to 16 are diagrams for describing a configuration and operation of the modulo-based positional encoding unit Mod-PEU, and separately describes a step-by-step operation of the modulo-based positional encoding. With reference to FIGS. 12 to 16, a more detailed configuration and operation of the PEU 123 will be described as follows.

FIG. 12 is a diagram for describing motivation for development of the Mod-PEU (Modulo-PEU). Referring to FIG. 12, in the existing DNN-based 3D rendering operation (Full NeRF), positional encoding does not take a large part of the operation. However, when performing the TF process of the BuFF architecture, only partial inference is performed and positional encoding takes up 94.7% of the operation quantity. Therefore, fast and efficient sine wave function generation is essential to maintain high-speed and low-power rendering.

FIG. 13 is a diagram illustrating an approximate equation (that is, periodic polynomial) including a quadratic function and a modulo function. Referring to FIG. 13, the PEU 123 of the present invention calculates a remainder of dividing sample coordinates in half-precision format by 2, takes the 2's complement thereof to generate first and second parameters, and then applies the first and second parameters to Equation 1 below to generate a plurality of sine waves and cosine waves required for positional encoding.

$$sin ( {2}^{- 1} π x ) \approx {( - 1 )}^{[ x / 2 ]} \cdot mod ( x , 2 ) \cdot mod ( 2 - x , 2 ) \qquad [ Equation 1 ]$$

$$cos ( {2}^{- 1} π x ) \approx {( - 1 )}^{[ ( x + 1 ) / 2 ]} \cdot mod ( x + 1 , 2 ) \cdot mod ( 1 - x , 2 )$$

The above equation imitates periodicity and the form of a sine function through multiplication of Modulo functions. It has been confirmed that there is no PSNR loss when performing DNN-based 3D rendering, and it can be seen that a simple equation is exhibited compared to the existing Taylor series expansion. In addition, according to the above equation, output is repeated at cycle 4 due to modulo calculation. A reason therefor is that the proposed approximation method has the same differentiable characteristic as that of the sine wave function, and a gradient direction is almost the same as that of the existing sine wave function. Therefore, the PEU 123 of the present invention may approximate a sinusoidal function with a simple periodic polynomial during positional encoding.

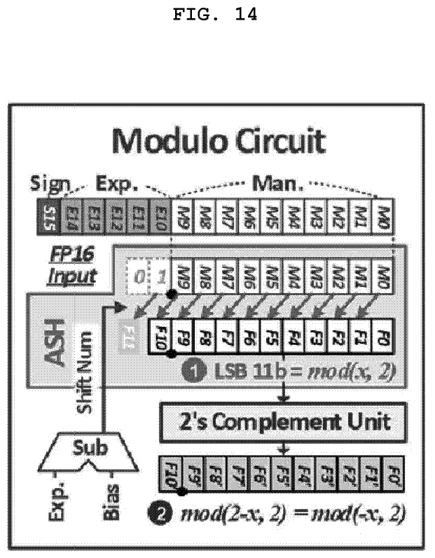

FIG. 14 is a diagram illustrating a basic operation unit of the Mod-PEU 123 for generating a periodic polynomial-based sine wave function, and illustrates a modulo circuit of the Mod-PEU 123 including the modulo circuit, a sign calculation circuit (SCC), and a magnitude calculation circuit (MCC).

Referring to FIG. 14, the modulo circuit creates mod(x, 2) and mod(2−x, 2), which are two modulo residues required for the approximation equation. To this end, the modulo circuit receives coordinates of a sample in an IEEE 754 half-precision format (Half-precision, Floating-point 16-bit, FP16) and obtains mod(x, 2) using a simple arithmetic bit shifter (Arithmetic Shifter, ASH). Thereafter, mod(2−x, 2) has the same value as mod(−x, 2), and thus may be simply calculated through a 2′ complement unit.

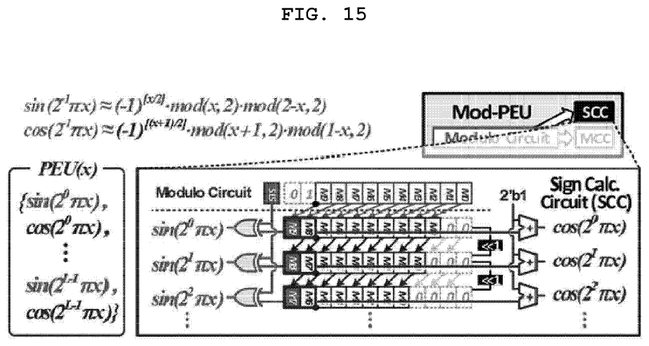

FIG. 15 is a diagram for describing the SCC that determines the sign of the periodic polynomial (that is, approximation equation). Referring to FIG. 15, the sign of the sine function may be obtained through an XOR operation result of the sign of input and MSB values after a bit shift operation, and the sign of the cosine function may be obtained by adding 2′ after the bit shift operation.

Meanwhile, positional encoding requires several encoding results including sequences of “the power of 2”. Therefore, both the SCC and the MCC, which will be described later, consider these characteristics and create 30 position encoding values in parallel.

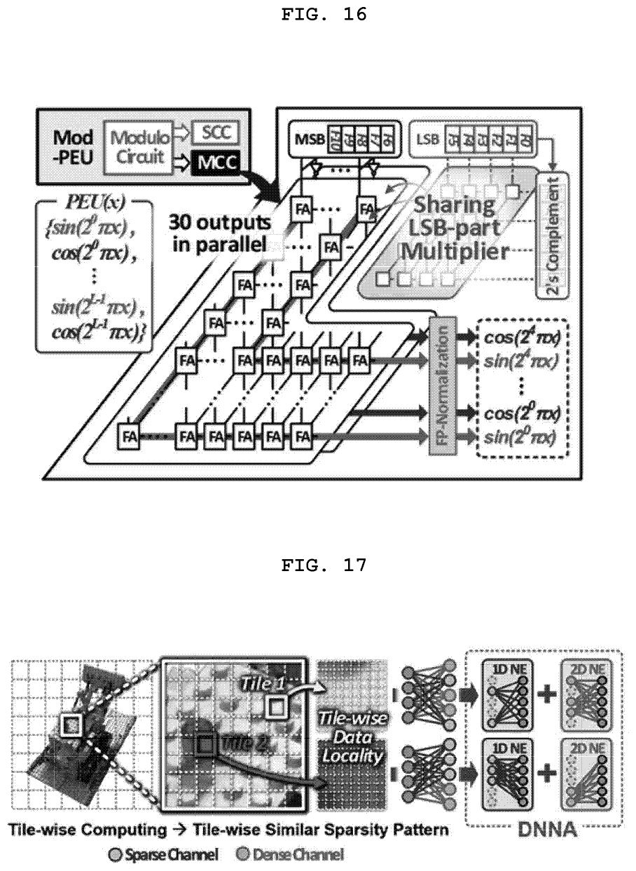

FIG. 16 is a diagram for describing the MCC. Referring to FIG. 16, modulo results generated by the modulo circuit are multiplied to simultaneously produce 30 sine and cosine function values, the magnitude of the sine function may be calculated by multiplying mod(x, 2) and mod(2−x, 2), and the cosine function may be calculated by multiplying mod(x+1, 2) and mod(1−x, 2). However, in this instance, when calculating the magnitude through the MCC, the same LSB multiplication result is required for both the sine and cosine functions, and considering the power of 2 multiplication, LSB multiplication may be reused to create multiple positional encoding results. Therefore, the MCC minimized circuit complexity by allowing 30 outputs to share results of the LSB part. That is, by sharing the LSB partial multiplier during multiple encoding result generation, the MCC additionally reduced power consumption by 38.2%.

In this way, the present invention may minimize the overhead of forming a sinusoidal wave. In other words, the Mod-PEU 123 required up to 96% lower power consumption and up to 90% lower area than the existing LUT or CORDIC methods, and was optimized for high-speed operation by being able to obtain several sine wave function values in a single operation cycle. Therefore, by applying the Mod-PEU 123, the present invention may accelerate DNN-based 3D rendering, including TF Evaluation, without significant performance degradation even when the BuFF architecture is adopted.

FIG. 17 is a diagram for describing a concept of a DNNA process according to an embodiment of the present invention, and illustrates a DNNA process for tile-unit images performed when output of the VPC 110 is transmitted to the HNE 120.

Referring to FIGS. 1 and 17, first, the VPC 110 divides the image subjected to 3D rendering into several tiles and then performs DNN inference for each tile to obtain RGB. In this instance, due to the feature of the present invention that performs operation for each tile, the RGB values for each tile are similar, and the distribution and pattern of intermediate DNN inference by-products have similar characteristics.

Meanwhile, the HNE 120 has the characteristic of sharing the same output t zero pattern (a pattern of “0” generated by the ReLU activation function) in the tile when accelerating images in units of tiles.

Therefore, the DNNA-C 130 may use these characteristics to derive an output zero pattern found for each tile, and then determine tasks to be allocated to the 1D NE 121 and the 2D NE 122 according to the output zero pattern.

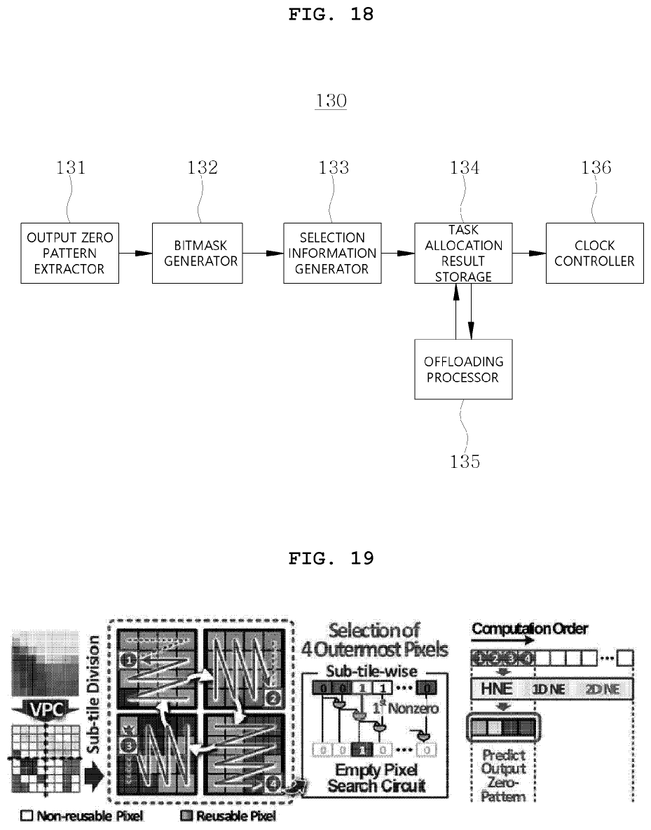

An example of a configuration of the DNNA-C 130 therefor is illustrated in FIG. 18.

FIG. 18 is a schematic block diagram of the DNNA core according to an embodiment of the present invention. Referring to FIG. 18, the DNNA core 130 according to an embodiment of the present invention includes an output zero pattern extractor 131, a bitmask generator 132, a selection information generator 133, a task allocation result storage 134, an offloading processor 135, and a clock controller 136.

The output zero pattern extractor 131 determines some of the DNN inference target pixels (that is, pixels that do not reuse RGB values of the previous frame) as sparsity reference pixels for each tile-unit image output from the VPC 110, and extracts an output zero pattern (that is, sparsity) of each of the sparsity reference pixels.

Meanwhile, task allocation requires a lot of waiting time to load the corresponding weights and reorder the IA values, and thus is impractical. Therefore, the present invention needs to determine an appropriate task allocation method as rapidly as possible to hide the latency of weight fetching and minimize the cost of data reordering. Therefore, to identify the output zero pattern in advance as rapidly as possible, the output zero pattern extractor 131 determines the sparsity reference pixel using centrifugal sampling (CS) and extracts the output zero pattern (that is, sparsity) of each of the sparsity reference pixels. A reason therefor is to speed up output prediction by performing neural network inference on some pixels for each tile and applying a sparsity pattern appearing in the corresponding pixel to other patterns as well. In other words, as a result, it is possible to reduce the operation quantity of the 3D rendering accelerator and ultimately speed up 3D rendering.

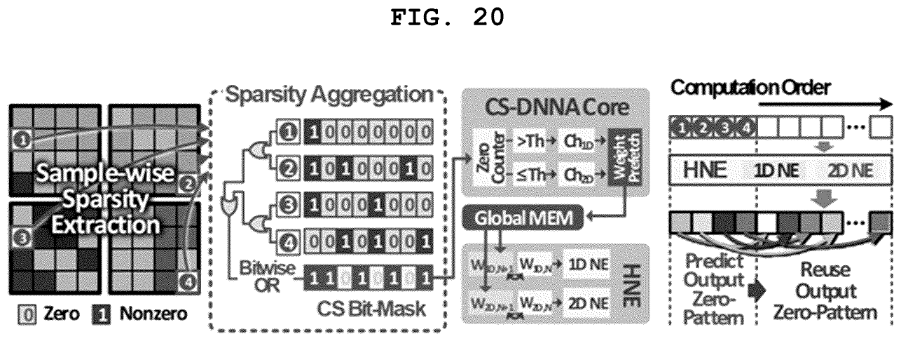

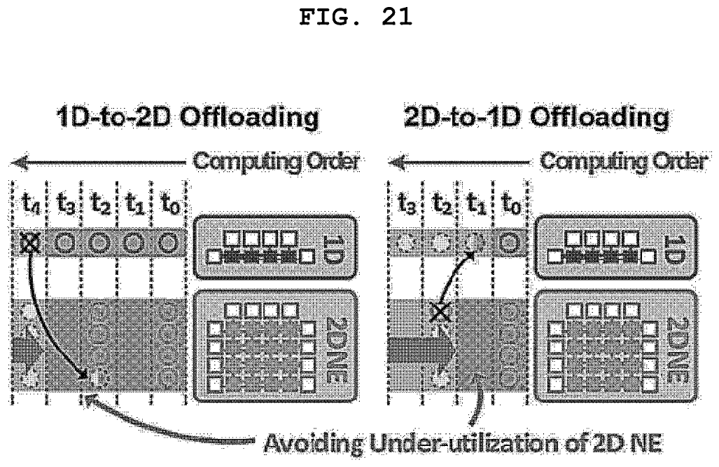

FIG. 19 is a diagram for describing such a CS method. Referring to FIG. 19, the output zero pattern extractor 131 first divides an 8×8 tile into four 4×4 tiles, and then selects a pixel furthest from a center based on a zigzag pattern order (that is, a zigzag order determined from the center to the periphery) predetermined for each tile as illustrated in FIG. 19. A reason therefor is to increase prediction accuracy by selecting four pixels having low relationship.

In this instance, as illustrated in FIG. 19, a process of selecting the furthest pixel may be performed by an empty pixel search circuit including only an AND gate and a NOT gate.

Meanwhile, the HNE 120 performs inference of 8 samples for each of four non-reusable pixels selected as such, then generates a CS-Bmap (another name, output zero pattern) representing NZ (NonZero) output, and transmits the generated CS-Bmap to the DNNA-C 130.

The bitmask generator 132 generates a bitmask representing the sparsity ratio by collecting the CS-Bmap (that is, output zero pattern) through a bitwise OR operation. In this way, the bitmask generator 132 may determine the worst case of the zero pattern to improve accuracy.

The selection information generator 133 generates selection information for allocating a task to one of the plurality of NEs according to the number of 0s in the bitmask.

FIG. 20 is a diagram for describing a dynamic allocation process by the bitmask generator 132 and selection information generator 133, and illustrates the dynamic allocation process after DNN inference results for pixels selected by the output zero pattern extractor 131 are input.

Referring to FIGS. 18 to 20, first, the bitmask generator 132 collects an output zero pattern for each pixel using a bitwise OR operation. In this instance, the bitmask generator 132 performs the bitwise OR operation to share the corresponding zero pattern with other surplus pixels only when all four pixels have a value “0” among various output zero patterns generated for each pixel.

Meanwhile, after the bitwise OR operation, the resultant bitmask is transmitted to the selection information generator 133 of the DNNA-C 130, and the selection information generator 133 allocates the corresponding channel to the 1D NE when the number of 0s is large and to the 2D NE when the number is small according to the number of 0s of the bitmask. Here, channel allocation refers to a process of transferring only a weight for the corresponding channel among weights stored in the external memory (global memory) 140 to the designated NE. Thereafter, on the assumption that the output zero pattern is the same as a CS bitmask, the 1D NE 121 and the 2D NE 122 continue to perform operations on the remaining pixels, and only operate on the allocated channels. The 1D NE 121 receives a channel whose sparsity is greater than a predetermined threshold and allocates the remaining channels to the 2D NE 122. Due to double buffering of an on-chip weight memory, this weight prefetch process may be completely hidden by implementing a pipeline using underlying DNN calculation.

The task allocation result storage 134 stores task allocation information. That is, the task allocation result storage 134 stores a task allocation result based on selection information generated by the selection information generator 133.

The offloading processor 135 monitors task allocation information of each of the plurality of NEs according to the selection information, performs task offloading according to an operation execution time occupancy characteristic of each of the plurality of NEs, and performs offloading to improve utilization of one NE having constant operation execution time occupancy among the plurality of NEs. In this way, efficiency of the HNE 120 may be increased. In other words, offloading may solve a problem of task allocation through a sparsity ratio in that performance of the HNE 120 may deteriorate due to low core utilization even though tasks are successfully divided to NEs.

FIG. 21 is a diagram for describing CS-based task offloading of the offloading processor 135. A left diagram of FIG. 21 illustrates an example in which an operation time may be optimized by transferring one channel allocated to the 1D NE to the 2D NE when one channel of the 2D NE is empty, and a right drawing of FIG. 21 illustrates an example in which the corresponding channel allocated to the 2D NE is transferred to the 1D NE so that the 2D NE does not need to perform the corresponding operation when only one channel is allocated to the 2D NE.

In other words, the 1D NE skips the operation when there is “0” in the input data, and thus is characterized in that the operation execution time significantly changes depending on the sparsity and the number of allocated channels, while the 2D NE requires the same operation time regardless of whether there are few or many channels allocated, and thus is characterized in that the channels allocated to the 2D NE need to be filled as much as possible to optimize the operation time. FIG. 21 illustrates an example of task offloading from 1D to 2D or 2D to 1D in a direction of preventing under-utilization of the 2D NE due to these characteristics.

In this way, the offloading processor 135 detects unuse of the 2D NE in advance, then performs 1D-to-2D or 2D-to-1D task offloading, and maintains the 2D NE in a full core use state, so that the present invention ultimately exhibits an average throughput improvement of 14.5%.

The clock controller 136 controls a clock of each of the plurality of NEs based on the bitmask generated by the bitmask generator 132, which uses a characteristic in that a zero pattern of output may be known in advance as a result of CS-based DNN inference. The clock controller 136 determines in advance useless calculation in the remaining samples or pixels from the bitmask and may reduce dynamic power consumption by clock-gating (CG) as a result thereof.

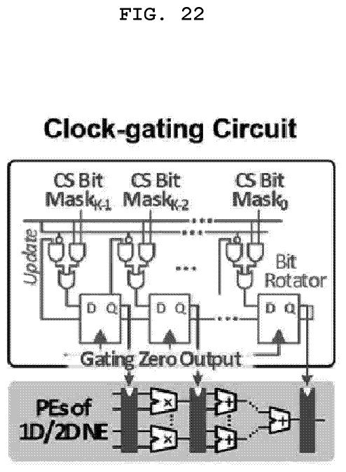

FIG. 22 is a diagram for describing the clock controller 136. The clock controller 136 will be described as follows with reference to FIG. 22.

First, the clock controller 136 is disposed in both the 1D NE and the 2D NE and receives a bitmask as an input signal. Meanwhile, a bit rotator creates a CG control signal to manage power consumption of a pipeline structure in a main PE array. CS-based CG may ultimately reduce dynamic power consumption of the HNE by up to 24.6%.

Meanwhile, the offloading processor 135 and the clock controller 136 may be installed inside the HNE 120 or in each of a plurality of NEs to improve performance of the HNE 120.

In this way, the HNE 120 may not only utilize two heterogeneous NEs but also optimize performance thereof using a dynamic management method through a CS-DNNA core. In other words, the HNE 120 of the present invention may achieve 3.7 times higher throughput than acceleration without using sparsity, and may achieve energy efficiency at least 2.4 times higher than the existing NE using only either the 1D NE or the 2D NE.

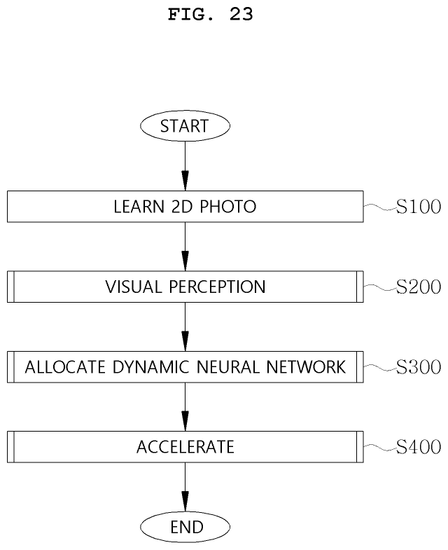

FIGS. 23 to 29 are processing flowcharts for a method of accelerating AI-based high-speed and low-power 3D rendering according to an embodiment of the present invention, and FIGS. 30 to 32 are diagrams for describing the method of accelerating AI-based high-speed and low-power 3D rendering according to the embodiment of the present invention.

With reference to FIGS. 1 to 29, the method of accelerating 3D rendering according to the embodiment of the present invention will be described as follows.

First, in step S100, the 3D rendering accelerator 100 of the present invention learns a 2D photo. That is, in step S100, the 3D rendering accelerator 100 of the present invention learns weights of the DNN using a plurality of 2D photos obtained by imaging the same object from various directions.

In step S200, the VPC 110 performs visual perception (VP). That is, in step S200, the VPC 110 creates an image plane for an object that is a 3D rendering target from a position and a direction of the observer, divides the image plane into a plurality of tile units, and then performs brain imitation visual recognition on the divided tile-unit images to determine to reduce a DNN inference range required for 3D rendering.

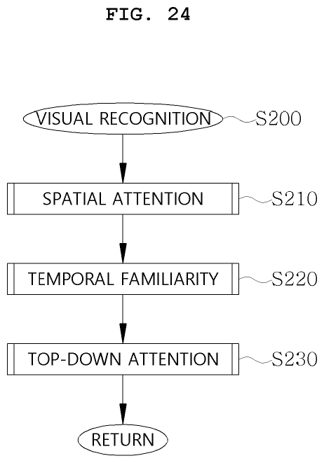

To this end, as illustrated in FIG. 24, the VPC 110 performs a spatial attention step S210, a temporal familiarity step S220, and a top-down attention step S230.

First, in step S210, the SAU 112 defines a low-resolution voxel in advance through a DNN trained without voxels, and samples only points in the voxel during the sampling process in the DNN-based 3D rendering operation to minimize the number of required samples (spatial attention).

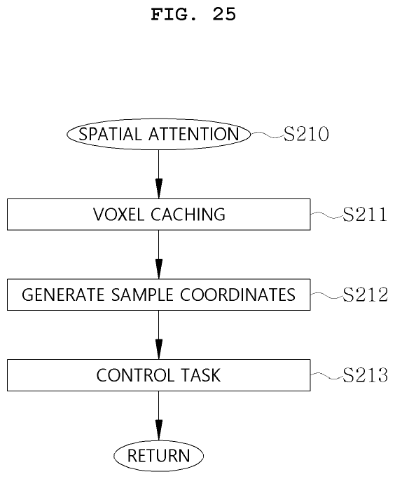

To this end, as illustrated in FIG. 25, the SAU 112 stores information about voxels collected from the external memory in a cache memory (voxel caching) in step S211, generates sample coordinates in step S212 such that a ray is fired in the gaze direction of the observer and only coordinates inside voxels corresponding to the DNN inference target pixels among the coordinates on the ray are generated as the sample coordinates (sample coordinate generation), classifies the tile-unit image as a dense tile or a sparse tile, and then controls input/output to/from the HNE 120 based on a classification result in step S213 (task control).

FIG. 30 schematically describes this spatial attention step (S210) and illustrates an SA process of a BuFF architecture. Referring to FIG. 30, the spatial attention (SA) step (that is, step S210) of the present invention utilizes an attention map to reduce the number of samples per ray. That is, step S210 illustrates an example of minimizing the number of required samples by collecting only meaningful samples within the attention map using low-resolution voxels. In this instance, the voxels may be obtained in a pre-training step by representing a subspace including high-density samples.

Further, in step S220, the TFU 111 determines a reused pixel value, which is a pixel value of the previous frame that may be reused, by evaluating familiarity of the previous frame and the current frame when the position of the observer changes, and determines DNN inference target pixels that require DNN inference among pixels in the frame (temporal familiarity) in consideration of the reused pixel value. In particular, the TFU 111 stores a DNN intermediate operation result of the previous frame in a memory, and then uses the DNN intermediate operation result as a partial sum to perform only partial inference, thereby minimizing the operation quantity.

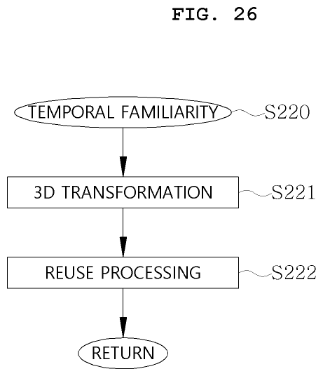

To this end, as illustrated in FIG. 26, in step S221, after performing 3D transformation on the tile-unit image, the TFU 111 rotates and parallel-transfers an RGB value for each pixel of the previous frame to project the RGB value onto a pixel of the corresponding current frame based on change values of the position and the direction of the observer (3D transformation). In step S222, the TFU 111 predicts a color change value in units of pixels of the previous frame and the corresponding current frame, and determines to reuse only an RGB value of a pixel in which the predicted color change value is less than the preset allowable change value (reuse processing).

In this instance, in step S221, the 3D transformer 11 rotates and parallel-transfers an RGB value for each pixel of the previous frame by utilizing the relative addressing-based buffering technique. In step S222, when an overlap phenomenon occurs where a plurality of previous frame pixels matches one current frame pixel, the reuse processor 12 further performs a process of solving intra-tile overlap by selecting an RGB value of a pixel located at the frontmost position among the previous frame pixels where overlap occurs, and solving inter-tile overlap through DNN inference.

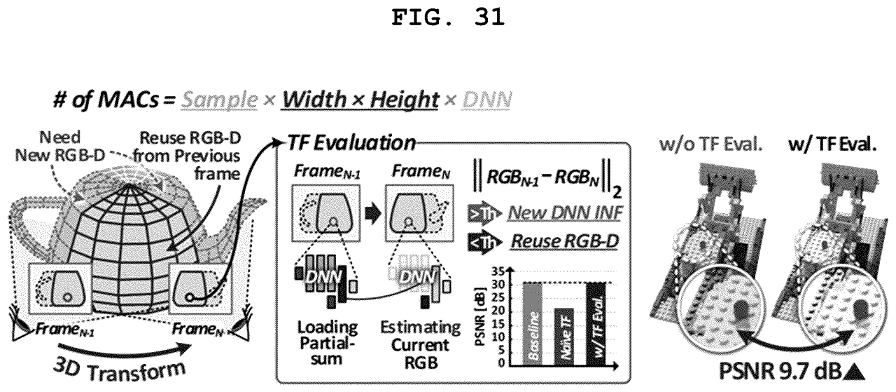

FIG. 31 schematically describes the temporal familiarity step S220 and illustrates the TF process of the BuFF architecture. Referring to FIG. 31, the temporal familiarity (TF) step (that is, step S220) of the present invention serves to reduce the number of pixels requiring new rendering by reusing RGB-D (red, green, blue, and depth) information obtained from the previous frame in the current frame. However, the number of pixels that may be reused through 3D transformation may be significantly large. However, when the pixels are used without change, PSNR loss of as much as 9.7 dB occurs, significantly damaging rendering quality. To prevent this, the present invention introduces TF Evaluation, which performs only a partial operation of the DNN to predict in advance whether the RGB change of the pixel to be reused will be large or small. When the RGB change is expected to be large, a new RGB change is induced to be found without reuse.

In step S230, the TDA logic 24 determines whether to continue inference and whether additional sampling is necessary, based on the DNN inference result (top-down attention).

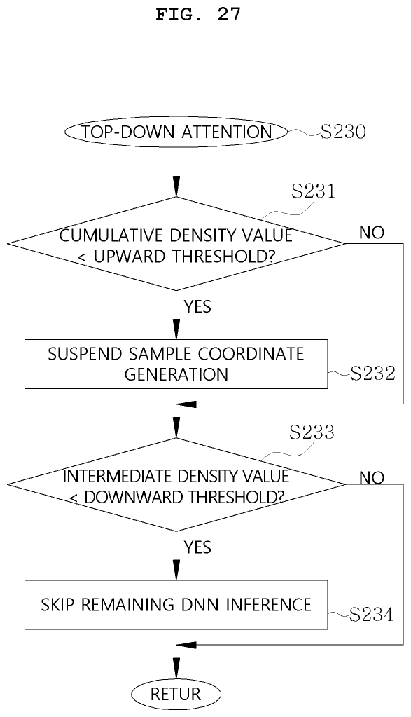

To this end, as illustrated in FIG. 27, in steps S231 and S232, the TDA logic 24 compares the cumulative density value of the entire 3D rendering process transmitted from the HNE 120 with a preset upward threshold, and determines whether to suspend the sample coordinate generation operation of the sample coordinate generator when the cumulative density value exceeds the preset upward threshold. Meanwhile, in steps S233 and S234, the TDA logic 24 compares the intermediate density value included in the intermediate operation result for any first layer transmitted from the HNE 120 with a preset downward threshold, and determines to skip the remaining DNN inference step of the first layer when the intermediate density value is less than the downward threshold.

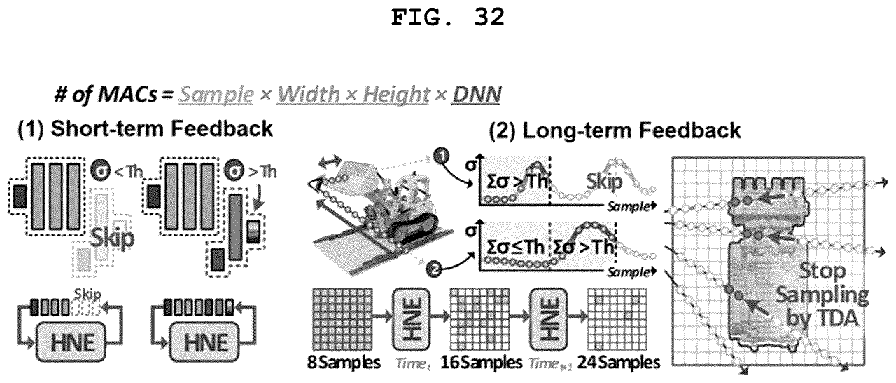

FIG. 32 is a diagram for describing the top-down attention (TDA) step according to an embodiment of the present invention, and illustrates the TF process of the BUFF architecture. Referring to FIG. 32, two types of feedback are applied together to the top-down attention (TDA) step (that is, step S230) of the present invention. The first feedback is short-term feedback, in which the remaining layer operation is continued when density serving as the intermediate operation result of the DNN is high, and the remaining operation is skipped when the density is low. The second feedback is long-term feedback, in which a sampling operation is suspended when the accumulated density value is sufficiently large, and sampling is continued when the accumulated density value is small. Whether to additionally perform or not to perform sampling is determined in units of 8 samples. This TDA step may ultimately reduce the total number of samples by 95.7% without additional PSNR loss.

In this way, when a tile-unit image having a minimized operation quantity is generated through step S200, in step S300, the DNNA-C 130 determines a DNN inference method for each of the tile-unit images based on the sparsity ratio of each of the tile-unit images. That is, in step S300, the DNNA-C 130 divides and allocates the DNN inference operation tasks included in the DNN inference range to a plurality of NEs having different operational efficiencies depending on the input sparsity, thereby determining a DNN inference method for each of the tile-unit images.

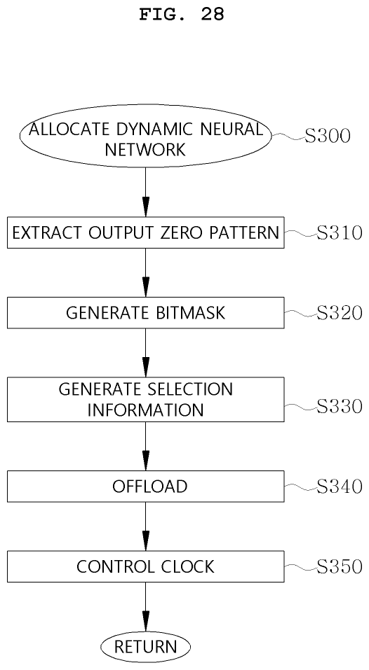

To this end, as illustrated in FIG. 28, the DNNA-C 130 performs an output zero pattern extraction step S310, a bitmask generation step S320, a selection information generation step S330, an offloading step S340, and a clock control step S350.

First, in the output zero pattern extraction step S310, the output zero pattern extractor 131 determines some of the DNN inference target pixels as sparsity reference pixels for each tile-unit image using CS, and extracts an output zero pattern for each of the sparsity reference pixels (output zero pattern extraction).

In the bitmask generation step S320, the bitmask generator 132 collects the output zero patterns of each of the sparsity reference pixels using a bitwise OR operation to generate a bitmask representing the sparsity ratio (bitmask generation).

In the selection information generation step S330, the selection information generator 133 generates selection information for allocating each of the tasks for DNN inference to one of the plurality of neural engines, and generates the selection information according to the number of 0s in the bitmask (selection information generation).

In the offloading step S340, task allocation information of each of the plurality of NEs is monitored according to the selection information, and task offloading is performed based on an operation execution time occupancy characteristic of each of the plurality of NEs so that utilization of one NE having constant operation execution time occupancy among the plurality of NEs is improved (offloading).

In the clock control step S350, the clock of each of the plurality of NEs is controlled based on the bitmask (clock control).

In this instance, the offloading step S340 and the clock control step S350 may be performed by the HNE 120.

In step S300, the HNE 120 accelerates DNN inference included in the DNN inference range using the DNN inference method determined in step S200.

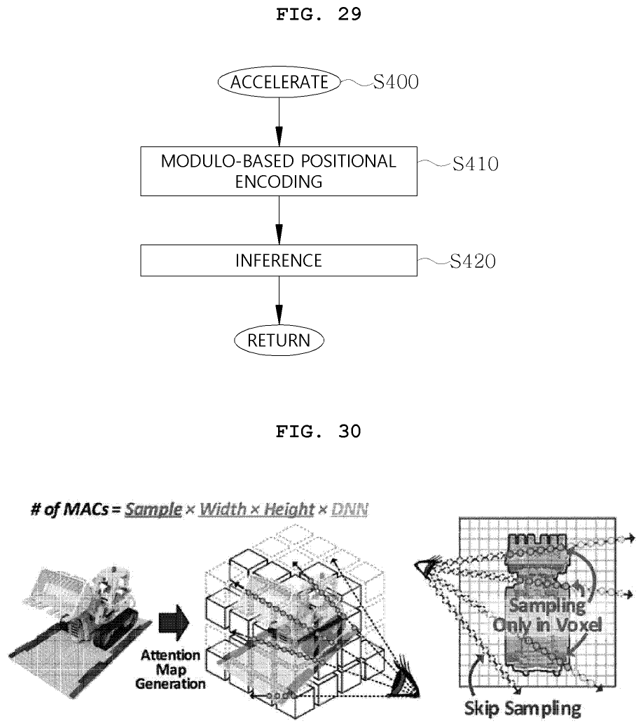

To this end, the HNE 120 performs modulo-based positional encoding S410 and an inference step S420, as illustrated in FIG. 29.

First, in step S410, the PEU 123 (that is, Mod PEU) generates a sine wave using an approximation formula including a quadratic function and a modulo function, and then performs positional encoding using the sine wave (modulo-based positional encoding).

In particular, step S410 calculates the remainder of dividing the sample coordinates in half-precision format by 2, takes the 2's complement thereof to generate first and second parameters, and then applies the first and second parameters to Equation 2 below to generate a plurality of sine waves and cosine waves required for positional encoding.

$$sin ( {2}^{- 1} π x ) \approx {( - 1 )}^{[ x / 2 ]} \cdot mod ( x , 2 ) \cdot mod ( 2 - x , 2 ) \qquad [ Equation 2 ]$$

$$cos ( {2}^{- 1} π x ) \approx {( - 1 )}^{[ ( x + 1 ) / 2 ]} \cdot mod ( x + 1 , 2 ) \cdot mod ( 1 - x , 2 )$$

In step S420, each of the tasks is inferred based on the selection information, and the corresponding tasks are DNN-inferred using any one of NEs allocated to each of the tasks among a 1D NE that skips the corresponding operation when there is 0 in input data and a 2D NE that reuses data regardless of whether there is 0 in input data (inference).

Meanwhile, in a NeRF algorithm, after performing positional encoding (step S410) and inference (step S420), a volume rendering process (not illustrated) is further performed, and a known technology may be used for the volume rendering process (not illustrated).

In the description of the 3D rendering method of the present invention with reference to FIGS. 23 to 32, redundant description of content described in the description of the 3D rendering accelerator with reference to FIGS. 1 to 22 has been omitted.

As described above, the present invention is characterized by being able to minimize the number of required samples by expressing a 3D space in advance using voxels and taking only samples located inside voxels when performing sampling to significantly reduce the operation quantity while minimizing external memory access, thereby improving rendering speed.

In addition, the present invention is characterized by being able to improve operational efficiency by adopting both a 1D NE utilizing data sparsity and a 2D NE maximizing data reusability and selectively applying one of the two NEs according to a sparsity ratio of an operation target image, thereby improving rendering speed.

In addition, the present invention is characterized by being able to reuse a pixel value of a previous frame according to a similarity between the previous frame and a current frame when a location of an observer changes to effectively reduce the number of pixels necessary for rendering, thereby reducing the operation quantity of a DNN to improve rendering speed.

In addition, the present invention is characterized by being able to minimize circuit complexity by approximating and replacing a sinusoidal function with a polynomial including a quadratic function and a modulo function during positional encoding, which is essential in DNN-based 3D rendering operation, reduce power and area consumption by generating several positional encoding results within one cycle, and as a result, accelerate DNN-based 3D rendering.

Meanwhile, the present invention provides a total of three operation modes, which are a power-efficient mode, a normal mode, and a high-speed mode. In the case of the power-efficient mode, power consumption is only 133 mW while maintaining 30 FPS or more, and in the case of the high-speed mode, the rendering speed may be increased up to 118 FPS. As a result, the present invention may achieve 911 times higher rendering speed and 99.95 times lower power consumption than those of NVIDIA's V100 server.

As described above, the AI-based high-speed and low-power 3D rendering accelerator and the method thereof of the invention have advantages in that it is possible to minimize the number of required samples by expressing a 3D space in advance using voxels and taking only samples located inside voxels when performing sampling to significantly reduce the operation quantity while minimizing external memory access, thereby improving rendering speed.

In addition, the present invention has advantages in that it is possible to improve operational efficiency by adopting both a 1D NE utilizing data sparsity and a 2D NE maximizing data reusability and dividing and allocating each of tasks having the reduced operation quantity to the 1D NE and the 2D NE according to a sparsity ratio of an operation target image, thereby improving rendering speed.

In addition, the present invention has advantages in that it is possible to reuse a pixel value of a previous frame according to a similarity between the previous frame and a current frame when a location of an observer changes to effectively reduce the number of pixels necessary for rendering, thereby reducing the operation quantity of a DNN to improve rendering speed.

In addition, the present invention has advantages in that it is possible to minimize circuit complexity by approximating and replacing a sinusoidal function with a polynomial including a quadratic function and a modulo function during positional encoding, which is essential in DNN-based 3D rendering operation, reduce power and area consumption by generating several positional encoding results within one cycle, and as a result, accelerate DNN-based 3D rendering.

In the above description, preferred embodiments of the present invention have been presented and described. However, the present invention is not necessarily limited thereto, and those skilled in the art to which the present invention pertains will easily understand that various substitutions, modifications, and changes may be made without departing from the technical spirit of the present invention.

1. An artificial intelligence (AI)-based high-speed and low-power three-dimensional (3D) rendering accelerator based on a deep neural network (DNN) trained using a weight of the DNN using a plurality of two-dimensional (2D) photos obtained by imaging the same object from several directions and then configured to perform 3D rendering using the same, the 3D rendering accelerator comprising:
a visual perception core (VPC) configured to create an image plane for an object that is a 3D rendering target from a position and a direction of an observer, divide the image plane into a plurality of tile units, and then perform brain imitation visual recognition on the divided tile-unit images to determine to reduce a DNN inference range required for 3D rendering;
a hybrid neural engine (HNE) including a plurality of neural engines (NEs) having different operational efficiencies according to input sparsity and configured to accelerate DNN inference included in the DNN inference range determined to be reduced by dividing and allocating tasks each having reduced operation quantity for the DNN inference to the plurality of NEs; and
a dynamic neural network allocation (DNNA) core configured to generate selection information for allocating each of the tasks to one of the plurality of NEs based on a sparsity ratio of each of the tile-unit images.

2. The 3D rendering accelerator according to claim 1, wherein the VPC comprises:
a temporal familiarity unit (TFU) configured to determine a reused pixel value, which is a pixel value of a previous frame allowed to be reused, by evaluating familiarity of the previous frame and a current frame when the position of the observer changes, determine DNN inference target pixels that require DNN inference among pixels of the current frame in consideration of the reused pixel value, and then generate a binary map representing the DNN inference target pixels; and
a spatial attention unit (SAU) configured to express the object using low-resolution voxels generated in advance, then exclusively generate coordinates located inside the voxels in a gaze direction of the observer as sample coordinates subjected to DNN inference, and exclusively generate coordinates located inside the voxels corresponding to the DNN inference target pixels as sample coordinates.

3. The 3D rendering accelerator according to claim 2, wherein the TFU comprises:
a 3D transformer configured to perform 3D transformation on the tile-unit images, then rotate and parallel-transfer RGB values for each pixel of the previous frame based on change values of the position and the direction of the observer, and project the RGB values onto corresponding pixels of the current frame; and
a reuse processor configured to predict a color change value in units of pixels of the previous frame and the corresponding current frame, and determine to exclusively reuse an RGB value of a pixel in which the predicted color change value is less than a preset allowable change value.

4. The 3D rendering accelerator according to claim 3, wherein the 3D transformer rotates and parallel-transfers the RGB values for each pixel of the previous frame by utilizing a relative addressing-based buffering technique.

5. The 3D rendering accelerator according to claim 3, wherein, when an overlap phenomenon occurs in which a plurality of previous frame pixels matches one current frame pixel, the reuse processor solves intra-tile overlap by selecting an RGB value of a pixel located at a frontmost side among the previous frame pixels where overlap occurs and solves inter-tile overlap by DNN inference.

6. The 3D rendering accelerator according to claim 2, wherein the SAU comprises:
a voxel cache configured to store information about the voxels collected from an external memory;
a sample coordinate generator configured to exclusively generate coordinates inside the voxels corresponding to the DNN inference target pixels among coordinates on a ray as sample coordinates by emitting the ray based on the binary map; and
a task controller configured to determine a number of effective samples for each of the DNN inference target pixels based on a result of sample coordinate generation, use a result thereof to classify the tile-unit images into a dense tile or a sparse tile, and then control input/output to/from the HNE according to a type thereof.

7. The 3D rendering accelerator according to claim 6, wherein the SAU further comprises top-down attention (TDA) logic configured to determine whether to continue inference based on a DNN inference result and control a sample coordinate generation operation of the sample coordinate generator,
wherein the TDA logic is configured to:
receive an intermediate operation result for any first layer from the HNE, and determine to skip remaining DNN inference steps of the first layer when an intermediate density value included in the intermediate operation result is less than a preset downward threshold, and
receive a cumulative density value generated throughout a 3D rendering process from the HNE, and determine to suspend the sample coordinate generation operation of the sample coordinate generator when the cumulative density value exceeds a preset upward threshold.

8. The 3D rendering accelerator according to claim 2, wherein the HNE comprises:
a 1D NE configured to skip a corresponding operation when there is 0 in input data;
a 2D NE configured to reuse data regardless of whether 0 is present in input data;
an input/output memory IOMEM configured to store input/output values of the 1D NE and the 2D NE; and
a modulo-based positional encoding unit (Mod-PEU) configured to generate a sine wave using an approximation formula including a quadratic function and a modulo function and perform positional encoding using the sine wave.

9. The 3D rendering accelerator according to claim 8, wherein the Mod-PEU calculates a remainder of dividing sample coordinates in half-precision format by 2, takes 2's complement thereof to generate first and second parameters, and then applies the first and second parameters to an equation below to generate a plurality of sine waves and cosine waves required for positional encoding:
$$sin ( {2}^{- 1} π x ) \approx {( - 1 )}^{[ x / 2 ]} \cdot mod ( x , 2 ) \cdot mod ( 2 - x , 2 ) \qquad ( Equation )$$
$$cos ( {2}^{- 1} π x ) \approx {( - 1 )}^{[ ( x + 1 ) / 2 ]} \cdot mod ( x + 1 , 2 ) \cdot mod ( 1 - x , 2 ) .$$

10. The 3D rendering accelerator according to claim 2, wherein the DNNA core comprises:
an output zero pattern extractor configured to determine some of the DNN inference target pixels as sparsity reference pixels for each of the tile-unit images using a centrifugal sampling (CS) method, and extract an output zero pattern of each of the sparsity reference pixels;
a bitmask generator configured to collect an output zero pattern for each of the sparsity reference pixels using a bitwise OR operation to generate a bitmask representing the sparsity ratio;
a selection information generator configured to generate selection information for allocating each of the tasks to one of the plurality of NEs according to a number of 0s in the bitmask;
an offloading controller configured to monitor task allocation information of each of the plurality of NEs according to the selection information, perform task offloading according to an operation execution time occupancy characteristic of each of the plurality of NEs, and perform offloading to improve utilization of one NE having constant operation execution time occupancy among the plurality of NEs; and
a clock controller configured to control a clock of each of the plurality of NEs based on the bitmask.

11. An AI-based high-speed and low-power 3D rendering method using a 3D rendering accelerator based on a DNN trained using a weight of the DNN using a plurality of 2D photos obtained by imaging the same object from several directions and then configured to perform 3D rendering using the same, the 3D rendering method comprising:
creating an image plane for an object that is a 3D rendering target from a position and a direction of an observer, dividing the image plane into a plurality of tile and units, then performing brain imitation visual recognition on the divided tile-unit images to determine to reduce a DNN inference range required for 3D rendering;
determining a DNN reference method of each of the tile-unit images based on a sparsity ratio of each of the tile-unit images by dividing and allocating operation tasks of DNN inference included in the DNN inference range to a plurality of NEs having different operational efficiencies according to input sparsity; and
accelerating the DNN inference using the DNN reference method determined in the determining a DNN reference method.

12. The 3D rendering method according to claim 11, wherein the creating comprises:
expressing the object using low-resolution voxels generated in advance, and then exclusively generating coordinates located inside the voxels in a gaze direction of the observer as sample coordinates subjected to DNN inference;
determining a reused pixel value, which is a pixel value of a previous frame allowed to be reused, by evaluating familiarity of the previous frame and a current frame when the position of the observer changes, and determining DNN inference target pixels that require DNN inference among pixels of the current frame in consideration of the reused pixel value; and
determining whether to continue inference and whether additional sampling is necessary based on a result of the DNN inference.

13. The 3D rendering method according to claim 12, wherein the expressing the object comprises:
storing information about the voxels collected from an external memory in a cache memory;
exclusively generating coordinates inside the voxels corresponding to the DNN inference target pixels among coordinates on a ray as sample coordinates by emitting the ray in the gaze direction of the observer; and
classifying the tile-unit images into a dense tile or a sparse tile, and then controlling input/output to/from an HNE according to a result of the classification.

14. The 3D rendering method according to claim 12, wherein the determining a reused pixel value comprises:
performing 3D transformation on the tile-unit images, then rotating and parallel-transferring RGB values for each pixel of the previous frame based on change values of the position and the direction of the observer, and projecting the RGB values onto corresponding pixels of the current frame; and
predicting a color change value in units of pixels of the previous frame and the corresponding current frame, and determining to exclusively reuse an RGB value of a pixel in which the predicted color change value is less than a preset allowable change value.

15. The 3D rendering method according to claim 14, wherein the performing 3D transformation comprises rotating and parallel-transferring the RGB values for each pixel of the previous frame by utilizing a relative addressing-based buffering technique.

16. The 3D rendering method according to claim 14, wherein the predicting a color change value comprises solving intra-tile overlap by selecting an RGB value of a pixel located at a frontmost side among the previous frame pixels where overlap occurs and solving inter-tile overlap by DNN inference when an overlap phenomenon occurs in which a plurality of previous frame pixels matches one current frame pixel.

17. The 3D rendering method according to claim 12, wherein the determining whether to continue inference and whether additional sampling is necessary comprises:
receiving a cumulative density value generated throughout a 3D rendering process from an HNE, and determining to suspend a sample coordinate generation operation of a sample coordinate generator when the cumulative density value exceeds a preset upward threshold; and
receiving an intermediate operation result for any first layer from the HNE, and determining to skip remaining DNN inference steps of the first layer when an intermediate density value included in the intermediate operation result is less than a preset downward threshold.

18. The 3D rendering method according to claim 12, wherein the determining a DNN reference method comprises:
determining some of the DNN inference target pixels as sparsity reference pixels for each of the tile-unit images using a CS method, and extracting an output zero pattern of each of the sparsity reference pixels;
collecting an output zero pattern for each of the sparsity reference pixels using a bitwise OR operation to generate a bitmask representing the sparsity ratio;
generating selection information for allocating each of tasks for the DNN inference to one of the plurality of NEs according to a number of 0s in the bitmask;
monitoring task allocation information of each of the plurality of NEs according to the selection information, performing task offloading according to an operation execution time occupancy characteristic of each of the plurality of NEs, and performing offloading to improve utilization of one NE having constant operation execution time occupancy among the plurality of NEs; and
controlling a clock of each of the plurality of NEs based on the bitmask.

19. The 3D rendering method according to claim 18, wherein the accelerating the DNN inference comprises:
generating a sine wave using an approximation formula including a quadratic function and a modulo function and performing positional encoding using the sine wave; and
inferring each of the tasks based on the selection information, and DNN-inferring corresponding tasks using any one of NEs allocated to each of the tasks among a 1D NE that skips a corresponding operation when there is 0 in input data and a 2D NE that reuses data regardless of whether there is 0 in input data.

20. The 3D rendering method according to claim 19, wherein the generating a sine wave comprises calculating a remainder of dividing sample coordinates in half-precision format by 2, taking 2's complement thereof to generate first and second parameters, and then applying the first and second parameters to an equation below to generate a plurality of sine waves and cosine waves required for positional encoding: [symbol]
